(19) United States
(12) Patent Application Publication
(10) Pub. No.: US 2019/0130795 A1
(43) Pub. Date: May 2, 2019

(54) DISPLAY CONTROL APPARATUS AND METHOD AND DISPLAY APPARATUS

(71) Applicants: BOE TECHNOLOGY GROUP CO., LTD., Beijing (CN); Ordos Yuansheng Optoelectronics Co., Ltd., Ordos (CN)

(72) Inventors: Hualing Yang, Beijing (CN); Lina Liu, Beijing (CN)

(21) Appl. No.: 16/168,458

(22) Filed: Oct. 23, 2018

(30) Foreign Application Priority Data
Oct. 30, 2017 (CN) 201711041357.4

(51) Int. Cl. G09F 9/30; G06F 1/32; G06F 1/16; G06F 3/041

(52) U.S. Cl. CPC G09F 9/301; G06F 1/3265; G06F 2203/04102; G06F 3/0416; G06F 1/1652

(57) ABSTRACT

The present disclosure relates to a display control apparatus and method and a display apparatus, and belongs to the field of display technologies. The display control apparatus includes a status obtaining module configured to determine either one of a first display area and a second display area as a primary display area and determine the other one as a secondary display area in response to a preset trigger action. The display control apparatus includes a resolution adjusting module configured to adjust image data transmitted to the display apparatus to match a resolution of the primary display area. The display control apparatus includes a display control module configured to control the primary display area to display based on the image data received by the display apparatus.

### CROSS-REFERENCE

This application is based upon and claims priority to Chinese Patent Application No. 201711041357.4, filed on Oct. 30, 2017, the entire contents thereof are incorporated herein by reference.

### TECHNICAL FIELD

The present disclosure pertains to the field of display technologies, and more particularly, to a display control apparatus and method and a display apparatus.

### BACKGROUND

With the development of display related technologies, flexible display devices, transparent display devices or the like have been developed. Users may fold or unfold the flexible display devices, and thus exposed surface areas of screens of electronic apparatuses may be significantly changed.

The flexible display devices may be organic light-emitting diode (OLED) display devices, liquid crystal display (LCD) devices, etc.

With the continuous development of display technologies, a variety of mobile portable flexible display devices spring up one after another, including bending, fixed curvature, folding, stretching, etc. However, after the flexible display devices are switched from flat panel display to folding display, only one side of the display content thereof may be observed by users, but the other side of the display content is unobservable, which may lead to that the users cannot receive all the contents transmitted from application processors (APs).

It is to be noted that the above information disclosed in this Background section is only for enhancement of understanding of the background of the present disclosure, and thus it may include information that does not constitute the prior art already known to those of ordinary skill in the art.

### SUMMARY

The present disclosure relates to a display control apparatus and method and a display apparatus.

According to an aspect of the present disclosure, there is provided a display control apparatus, which is used in a foldable display apparatus. The display apparatus includes a first display area and a second display area positioned on two sides of a fold line. The display control apparatus includes
a status obtaining module configured to determine one of the first display area and the second display area as a primary display area and determine the other one as a secondary display area in response to a preset trigger action. The display control apparatus further includes
a resolution adjusting module configured to adjust image data transmitted to the display apparatus to match a resolution of the primary display area. The display control apparatus further includes
a display control module, configured to control the primary display area to display based on the image data received by the display apparatus.

In an exemplary arrangement of the present disclosure, the display control module is further configured to control the secondary display area to go into a standby mode.

In an exemplary arrangement of the present disclosure, the determining either one of the first display area and the second display area as the primary display area and determining the other one as the secondary display area in response to a preset trigger action includes
detecting whether the received trigger action is a first trigger action or a second trigger action. Determining one of the first display area and the second display area as the primary display area and determining the other one as the secondary display area in response to a preset trigger action further includes
determining the first display area as the primary display area and determining the second display area as the secondary display area when the received trigger action is the first trigger action, or
determining the second display area as the primary display area and determining the first display area as the secondary display area when the received trigger action is the second trigger action.

In an exemplary arrangement of the present disclosure, the determining either one of the first display area and the second display area as the primary display area and determining the other one as the secondary display area in response to a preset trigger action includes
detecting whether a folding action is received, and obtaining a folding direction when the folding action is received,
determining the first display area as the primary display area and determining the second display area as the secondary display area when the obtained folding direction is a first direction, and
determining the second display area as the primary display area and determining the first display area as the secondary display area when the obtained folding direction is a second direction.

In an exemplary arrangement of the present disclosure, determining either one of the first display area and the second display area as the primary display area and determining the other one as the secondary display area in response to a preset trigger action includes
determining either one of the first display area and the second display area as the primary display area and determining the other one as the secondary display area based on a user command when a power saving mode selecting operation is received.

In an exemplary arrangement of the present disclosure, the power saving mode includes a standby mode or an always-on-display mode.

According to another aspect of the present disclosure, there is further provided a display control method, which is used in a foldable display apparatus. The display apparatus includes a first display area and a second display area positioned on two sides of a fold line. The display control method includes
determining either one of the first display area and the second display area as a primary display area and determining the other one as a secondary display area in response to a preset trigger action. The display control method includes
adjusting image data transmitted to the display apparatus to match a resolution of the primary display area. The display control method includes
controlling the primary display area to display based on the image data received by the display apparatus.

In an exemplary arrangement of the present disclosure, the display control method further includes controlling the secondary display area to go into a standby mode.

In an exemplary arrangement of the present disclosure, the determining either one of the first display area and the second display area as the primary display area and determining the other one as the secondary display area in response to a preset trigger action includes
detecting whether the received trigger action is a first trigger action or a second trigger action,
determining the first display area as the primary display area and determining the second display area as the secondary display area when the received trigger action is the first trigger action; and
determining the second display area as the primary display area and determining the first display area as the secondary display area when the received trigger action is the second trigger action.

In an exemplary arrangement of the present disclosure, the determining either one of the first display area and the second display area as the primary display area and determining the other one as the secondary display area in response to a preset trigger action includes
detecting whether a folding action is received, and obtaining a folding direction when the folding action is received. Determining either one of the first display area and the second display area as the primary display area and determining the other one as the secondary display area in response to a preset trigger action further includes
determining the first display area as the primary display area and determining the second display area as the secondary display area when the obtained folding direction is a first direction, or
determining the second display area as the primary display area and determining the first display area as the secondary display area when the obtained folding direction is a second direction.

In an exemplary arrangement of the present disclosure, the determining either one of the first display area and the second display area as the primary display area and determining the other one as the secondary display area in response to a preset trigger action includes
determining either one of the first display area and the second display area as the primary display area and determining the other one as the secondary display area based on a user command when a power saving mode selecting operation is received.

In an exemplary arrangement of the present disclosure, the power saving mode includes a standby mode or an always-on-display mode.

In an exemplary arrangement of the present disclosure, the display control method further includes
detecting whether a flip angle of a spatial attitude of the display apparatus is greater than a preset value, and
controlling the first display area and the second display area to switch over display contents when detecting that the flip angle of the spatial attitude of the display apparatus is greater than the preset value.

According to still another aspect of the present disclosure, there is further provided a display apparatus, including: a first display area and a second display area positioned on two sides of a fold line; a processor; and a memory, having a computer-executable instruction stored thereon, that when executed by the processor, caused the processor to execute the display control method of any one of the above arrangements.

It is to be understood that both the foregoing general description and the following detailed description are exemplary and explanatory only and are not restrictive of the present disclosure.

### BRIEF DESCRIPTION OF THE DRAWINGS

The accompanying drawings herein are incorporated in and constitute a part of this specification, illustrate arrangements conforming to the present disclosure and together with the description serve to explain the principles of the present disclosure. Apparently, the accompanying drawings in the following description show merely some arrangements of the present disclosure, and persons of ordinary skill in the art may still derive other drawings from these accompanying drawings without creative efforts.

FIG. 1 is a schematic diagram of a display control apparatus according to the present disclosure;

FIG. 2 is structural diagram I of the display control apparatus according to the present disclosure;

FIG. 3 is structural diagram II of the display control apparatus according to the present disclosure;

FIG. 4 is a status display diagram of the display control apparatus according to the present disclosure;

FIG. 5 is structural diagram III of the display control apparatus according to the present disclosure;

FIG. 6 is Flowchart I of a display control method according to the present disclosure;

FIG. 7 is Flowchart II of the display control method according to the present disclosure;

FIG. 8 is Flowchart III of the display control method according to the present disclosure;

FIG. 9 is Flowchart IV of the display control method according to the present disclosure; and

FIG. 10 is a structural diagram of a display apparatus according to the present disclosure.

### DETAILED DESCRIPTION

Exemplary arrangements will be described more comprehensively by referring to accompanying drawings now. However, the exemplary arrangements can be embodied in many forms and should not be construed as limited to the arrangements set forth herein; rather, these arrangements are provided so that the present disclosure will be made thorough and complete, and the concept of the exemplary arrangements will be fully conveyed to those skilled in the art. Furthermore, the described features, structures, or characteristics may be combined in any suitable manner in one or more arrangements. Many concrete details are provided in the following descriptions for a full understanding of the arrangements of the present disclosure. However, those skilled in the art will appreciate that the technical solutions in the present disclosure may be practiced without one or more of the specific details, or that other methods, elements, apparatuses, steps and so on may be employed. In other instances, well-known technical solutions are not shown or described in detail to avoid obscuring aspects of the present disclosure.

In addition, the accompanying drawings are merely exemplary illustration of the present disclosure, and are not necessarily drawn to scale. The same reference numerals in the drawings denote the same or similar parts, and thus repeated description thereof will be omitted. Some block diagrams shown in the figures are functional entities and not necessarily to be corresponding to a physically or logically individual entities. These functional entities may be implemented in software form, or implemented in one or more hardware modules or integrated circuits, or implemented in different networks and/or processor apparatuses and/or microcontroller apparatuses. It is to be noted that “first” and “second” are only used herein to distinguish entities or operations having the same names, rather than imply order or relationship between these entities or operations.

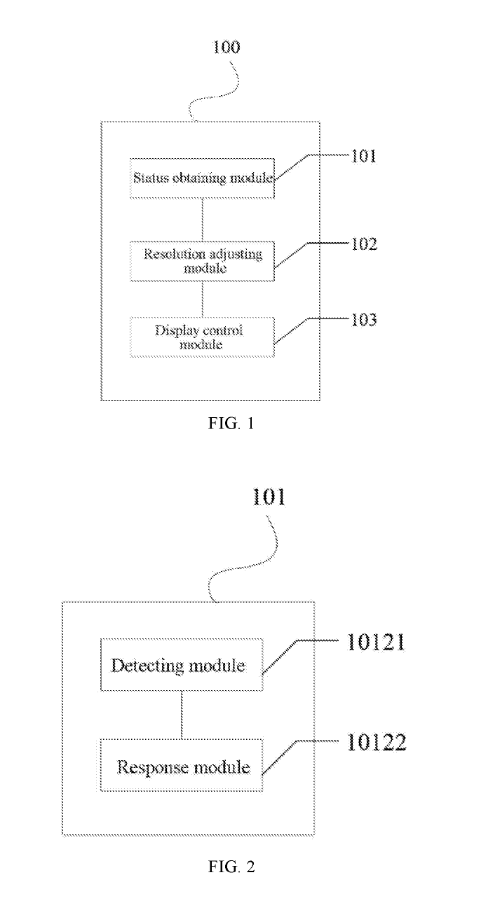

Referring to FIG. 1, a schematic diagram of a display control apparatus is shown according to an arrangement of the present disclosure. The display control apparatus is used in a foldable display apparatus, which includes a first display area and a second display area positioned on two sides of a fold line. The display control apparatus 100 may include: a status obtaining module 101, a resolution adjusting module 102, and a display control module 103.

The status obtaining module 101 is configured to determine either one of the first display area and the second display area as a primary display area and determine the other one as a secondary display area in response to a preset trigger action.

The resolution adjusting module 102 is configured to adjust image data transmitted to the display apparatus to match a resolution of the primary display area.

The display control module 103 is configured to control the primary display area to display based on the image data received by the display apparatus.

The preset trigger action may include a folding action of the foldable display apparatus, and also may include an input selection of a user. When the preset trigger action is the folding action of the foldable display apparatus, referring to FIG. 2, the status obtaining module 101 may include: a detecting module 10121, configured to detect the folding action and detect a folding direction; a response module 10122, configured to select a display area based on the folding direction after the detecting module 10121 detects the folding action and the folding direction. For example, when the folding direction is selected to be the first display area upward, the first display area is determined as the primary display area and the second display area is determined as the secondary display area. When the folding direction is selected to be the second display area upward, the second display area is determined as the primary display area and the first display area is determined as the secondary display area. The primary display area also may be determined based on a fact whether the display area is towards a human eye or face. A recognition may be made by adding human eye or face feature recognition apparatuses to determine the primary display area as the first display area or the second display area.

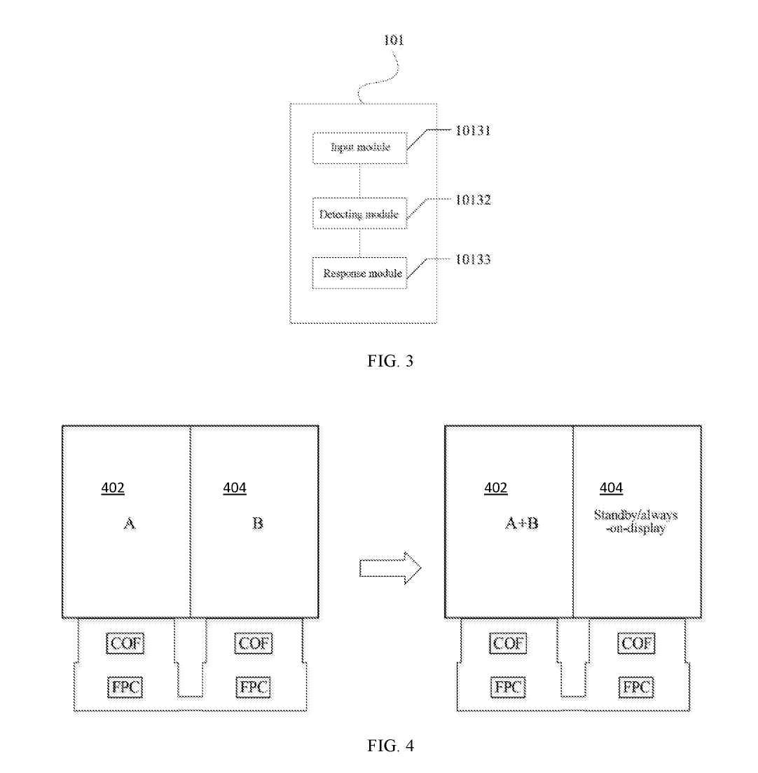

When the preset action is the user's input selection, referring to FIG. 3, the status obtaining module 101 may include: an input module 10131, configured to receive the user's input selection; a detecting module 10132, configured to detect the input selection of the input module 10131; and a response module 10133, configured to determine either one of the first display area and the second display area as the primary display area and determine the other one as the secondary display area based on the detected input selection. For example, when the user presses a standby key up, the first display area is determined as the primary display area for display, whereas the second display area is in standby. When the user presses the standby key down, the second display area is determined as the primary display area for display, whereas the first display area is in standby. The specific standby mode and key selection may be designed into a terminal device in a preset way. Of course the standby mode also may be an always-on-display mode.

The resolution adjusting module 102 is configured to adjust image data transmitted to the display apparatus. After the primary display area is determined, it is required to process the content of the first display area and the content of the second display area, and the entire contents of the two display areas are integrated into the primary display area. At this moment, the image data transmitted to the display apparatus are adjusted by means of the resolution adjusting module. For example, the display contents of the two display areas are integrated as data information whose source-direction resolution is halved to match a resolution of the primary display area. FIG. 4 shows a display content A of the first display area (402) and a display content B of the second display area (404) of the foldable display apparatus. By adjusting image data of the display content A and the display content B, the content A+B is displayed in either the first display area or the second display area.

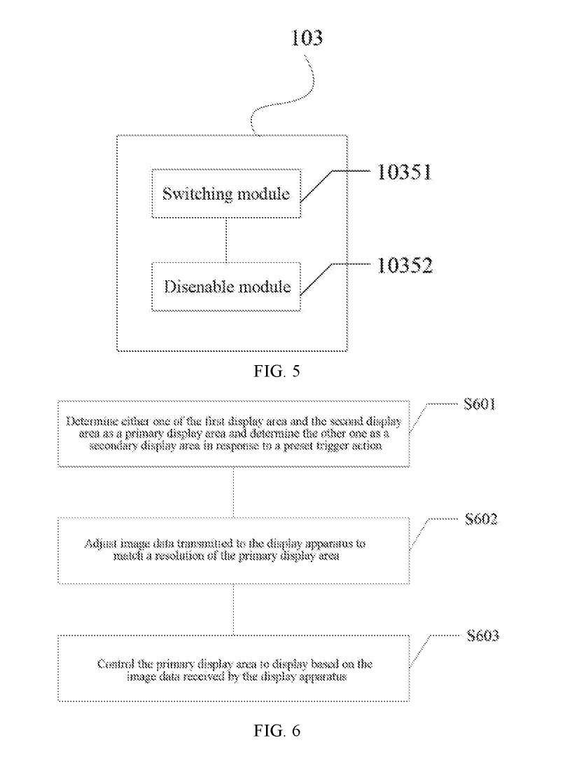

In an arrangement, referring to FIG. 5, the display control module 103 may include a switching module 10351 and a disenable module 10352. The switching module 10351 may be configured to control the primary display area to display based on the image data received by the display apparatus. The disenable module 10352 may be configured to control the secondary display area to go into a standby state or an always-on-display state.

The present disclosure provides a display control apparatus, which is used in a foldable display apparatus. The display apparatus includes a first display area and a second display area positioned on two sides of a fold line. The display control apparatus 100 may include: a status obtaining module 101, configured to determine either one of a first display area and a second display area as a primary display area and determine the other one as a secondary display area in response to a preset trigger action; a resolution adjusting module 102, configured to adjust image data transmitted to the display apparatus to match a resolution of the primary display area; and a display control module 103, configured to control the primary display area to display based on the image data received by the display apparatus. In one aspect, all images displayed in the first display area and the second display area may be controlled to be displayed in the primary display area, and in another aspect, the secondary display area may be controlled to go into a standby mode, thus achieving an objective of reducing power consumption.

Referring to FIG. 6, a flowchart of the display control method is shown according to an arrangement of the present disclosure. The display control method is used in a foldable display apparatus, which includes a first display area and a second display area positioned on two sides of a fold line. The display control method may include following:

S601: determining either one of the first display area and the second display area as a primary display area and determining the other one as a secondary display area in response to a preset trigger action;

S602: adjusting image data transmitted to the display apparatus to match a resolution of the primary display area; and

S603: controlling the primary display area to display based on the image data received by the display apparatus.

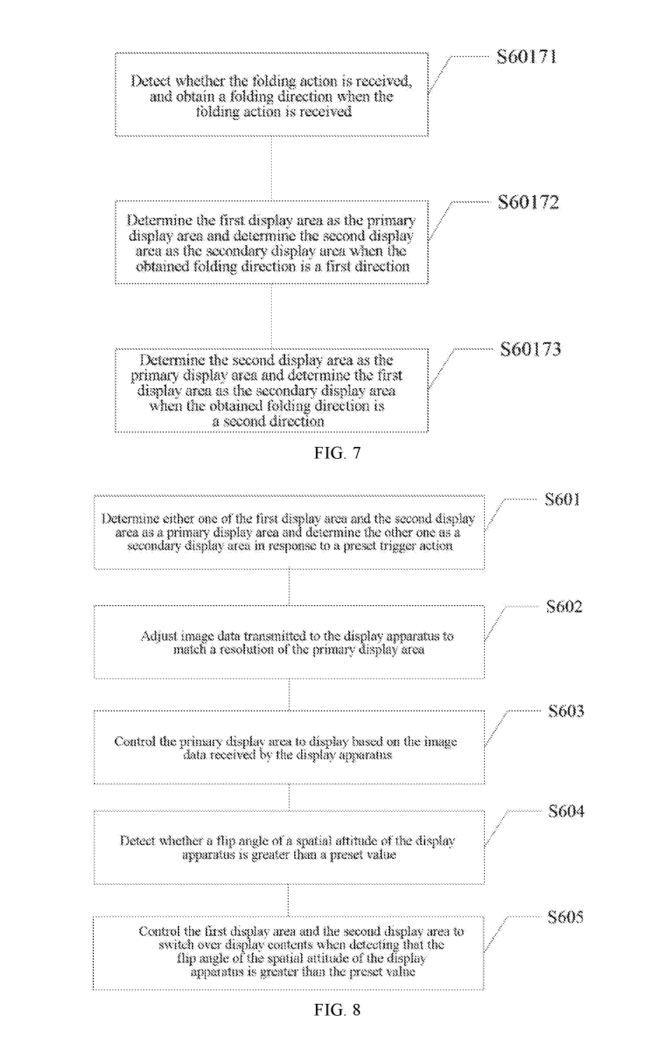

The preset trigger action may be a folding action or may be an input selection of a user. When the preset trigger action is the folding action, referring to FIG. 7, S601 may include following:

S60171: detecting whether the folding action is received, and obtaining a folding direction when the folding action is received;

S60172: determining the first display area as the primary display area and determining the second display area as the secondary display area when the obtained folding direction is a first direction; and

S60173: determining the second display area as the primary display area and determining the first display area as the secondary display area when the obtained folding direction is a second direction.

In an arrangement, referring to FIG. 8, after the primary display area is controlled to display, the method further includes following:

S604: detecting whether a flip angle of a spatial attitude of the display apparatus is greater than a preset value; and

S605: controlling the first display area and the second display area to switch over display contents when detecting that the flip angle of the spatial attitude of the display apparatus is greater than the preset value.

In this arrangement of the present disclosure, after the display content of either display area is displayed by means of the foldable display apparatus, the flip angle of the spatial attitude of the mobile terminal is detected in real time. For example, the flip angle of the spatial attitude of the display apparatus may be detected by means of an accelerometer or a gyroscope. The first display area and the second display area are controlled to switch over the display contents when detecting that the flip angle is greater than the preset value. For example, if before flipping the spatial attitude, the display apparatus displays the display content by means of the first display area, the first display area is switched to the second display area to display the display content. That is, the display screen is switched to the second display area and the first display area is closed (originally the second display area does not display, and thus after switching over the display content, the first display area is closed). If before flipping the spatial attitude, the mobile terminal displays the display content by means of the second display area, the second display area is switched to the first display area to display the display content. That is, the display screen is switched to the first display area and the second display area is closed (originally the first display area does not display, and thus after switching over the display content, the second display area is closed).

In this arrangement of the present disclosure, switchover of the display screen is automatically controlled by detecting variation information of the spatial attitude of the display apparatus, which makes screen switching operation more convenient.

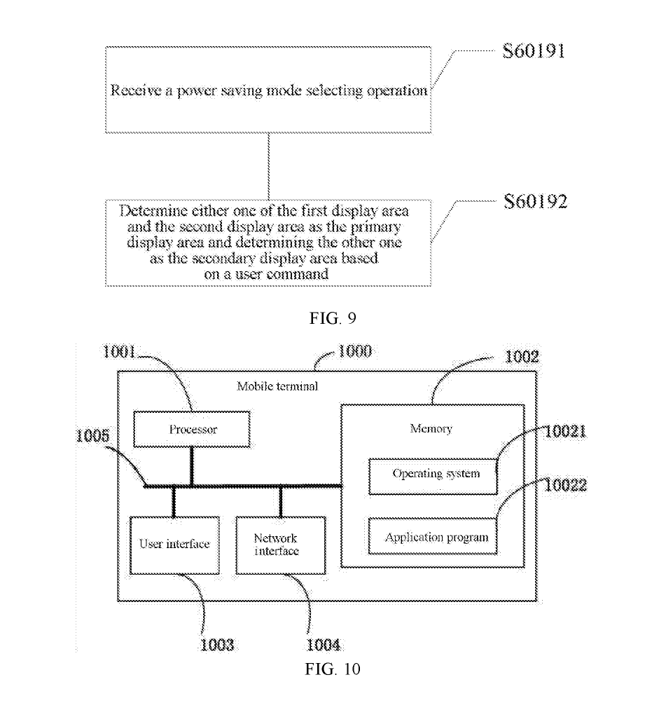

When the preset trigger action is an input selection of a user, referring to FIG. 9, S601 may include the following:

S60191: receiving a power saving mode selecting operation; and

S60192: determining either one of the first display area and the second display area as the primary display area and determining the other one as the secondary display area based on a user command.

In S60191, the input operation of the user is received, and the power saving mode is selected, wherein the power saving mode may be a standby mode or an always-on-display mode.

S60192 has been described in the foregoing apparatus, and thus its description is omitted herein.

In this arrangement of the present disclosure, when the foldable display apparatus is in an unfolded state, the display content may be jointly displayed by means of the first display area and the second display area. When the foldable display apparatus is in a folded state, the display content may be displayed by means of a screen in the first display area or the second display area. Therefore, the display screen becomes large when the foldable screen is switched from the folded state to the unfolded state. To enable the display interface adapt to the current display screen, it is required to adjust the displayed image data. The image data are jointly displayed by means of the first display area and the second display area. When the user does not need the screen of the display apparatus to display, that is, the foldable screen is switched from large screen display to small screen display, the first display area and/or the second display area may be closed to further reduce power consumption of the mobile terminal, thus prolong the endurance time of the mobile terminal.

Referring to FIG. 10, a structural diagram of a display apparatus is shown according to an arrangement of the present disclosure. As shown, the display apparatus 1000 includes at least one processor 1001, a memory 1002, at least one network interface 1004, and a user interface 1003. Components in the display apparatus 1000 are coupled together through a bus system 1005. It may be understood that the bus system 1005 is configured to implement connection communication between these components. In addition to a data bus, the bus system 1005 further includes a power bus, a control bus, and a status signal bus, etc. However, for clarity, all the buses in FIG. 10 are marked as the bus system 1005.

The user interface 1003 may include a display, a keyboard or a pointing device (such as a mouse or a trackball), a touchpanel or a touchscreen, etc.

It can be understood that the memory 1002 in the arrangements of the present disclosure may be a volatile memory or a non-volatile memory, or may include both of a volatile memory and a non-volatile memory. The non-volatile memory may include: a read-only memory (ROM), a programmable read-only memory (PROM), an erasable programmable read-only memory (EPROM), an electrically erasable programmable read-only memory (EEPROM), or a flash memory. The volatile memory may include a random access memory (RAM), which is used as an external cache. According to description that can be used as an example but imposes no limitation, RAMs of many forms are applicable, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DRRAM). The memory 1002 in the system and the method described in this specification intends to include, but is not limited to, these memories and any other memory of a suitable type.

In some implementation manners, the memory 1002 stores the following elements: an executable module or a data structure, or their subsets, or their extension sets: an operating system 10021 and an application program 10022.

The operating system 10021 includes various system programs such as a framework layer, a core library layer, a drive layer and so on to implement various basic services and process hardware-based tasks. The application program 10022 includes various application programs such as a media player, a browser and so on to implement various application services. Programs for implementing the method according to the arrangements of the present disclosure may be contained in the application program 10022.

In the arrangements of the present disclosure, by calling programs or instructions stored in the memory 1002, for example, programs or instructions stored in the application program 10022, the processor 1001 is configured to determine either one of the first display area and the second display area as the primary display area and determine the other one as the secondary display area in response to a preset trigger action, adjust image data transmitted to the display apparatus to match a resolution of the primary display area, and control the primary display area to display based on the image data received by the display apparatus.

The methods disclosed in the foregoing arrangements of the present disclosure may be applied to the processor 1001, or may be implemented by the processor 1001. The processor 1001 may be an integrated circuit chip and has a signal processing capability. In an implementation process, the foregoing methods may be implemented by using an integrated logic circuit of hardware in the processor 1001 or an instruction in a software form. The foregoing processor 1001 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The methods, steps, and logical block diagrams disclosed in the arrangements of the present disclosure may be implemented or executed. The general-purpose processor may be a microprocessor, or the processor may be any conventional processor or the like. The methods disclosed in the arrangements of the present disclosure may be directly executed by a hardware decoding processor, or may be executed by a combination of hardware and software modules in a decoding processor. The software module may be located in a mature storage medium in the field, such as a random access memory, a flash memory, a read-only memory, a programmable read-only memory, an electrically-erasable programmable memory, or a register. The storage medium is located in the memory 1002, and the processor 1001 reads information in the memory 1002 and implements the foregoing methods in combination with the hardware of the processor 1001.

It may be understood that these arrangements described in this specification may be implemented by hardware, software, firmware, middleware, microcode or a combination thereof. For hardware implementation, a processing unit may be implemented in one or more application specific integrated circuits (ASICs), digital signal processor (DSPs), digital signal processing devices (DSP Devices, DSPDs), programmable logic devices (PLDs), field-programmable gate arrays (FPGAs), general-purpose processors, controllers, micro-controllers, microprocessors, other electronic units for performing the functions in the present disclosure, or a combination thereof.

For software implementation, the technology described in this specification may be implemented by using modules for executing the functions (for example, a process or a function) described in this specification. Software code may be stored in a memory and executed by a processor. The memory may be implemented inside a processor or outside a processor.

In an arrangement, the processor 1001 selects either one of the first display area and the second display area as a primary display area and selects the other display area as a secondary display area based on the preset trigger action, which specifically includes: detecting whether a folding action is received, and obtaining a folding direction when the folding action is received; determining the first display area as the primary display area and determining the second display area as the secondary display area when the obtained folding direction is a first direction; and determining the second display area as the primary display area and determining the first display area as the secondary display area when the obtained folding direction is a second direction.

In an arrangement, the processor 1001 selects either one of the first display area and the second display area as a primary display area and selects the other display area as a secondary display area based on the preset trigger action, which specifically includes: determining either one of the first display area and the second display area as the primary display area and determining the other one as the secondary display area based on a user command when a power saving mode selecting operation is received.

In an arrangement, the processor 1001 is also configured to detect whether a flip angle of a spatial attitude of the mobile terminal is greater than a preset value after controlling the display screen to display, and control the first display area and the second display area to switch over display contents when detecting that the flip angle of the spatial attitude of the mobile terminal is greater than the preset value.

In an arrangement, the processor 1001 controls the display screen to display, which specifically includes: adjusting image data transmitted to the display apparatus to match a resolution of the primary display area when the foldable screen is switched from the unfolded state to the folded state; and controlling the primary display area to display based on the image data received by the display apparatus.

In an arrangement, the processor 1001 is also configured to adjust image data transmitted to the display apparatus to match a resolution of the primary display area when the foldable screen is switched from the folded state to the unfolded state, and control the primary display area to display based on the image data received by the display apparatus.

The display apparatus 1000 can implement procedures implemented by the mobile terminal in the foregoing arrangements, and thus their detailed descriptions are omitted herein to avoid repetitions.

In the arrangements provided in the present disclosure, it should be understood that the disclosed apparatuses and methods may be implemented by means of other manners. For example, the apparatus arrangements described above are merely exemplary. For example, a unit partition is merely a logic functional partition. In actual implementation, additional manners of partitioning may be available. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, i.e., either located at one place or distributed on a plurality of network units. Units may be selected in part or in whole according to actual needs to implement the objectives of the solutions of the arrangements of the present disclosure.

In addition, functional units in the arrangements of the present disclosure may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solution of the present disclosure in essence or that part of contribution to the prior art or a part of the technical solution may be embodied in the form of software products, which may be stored in a storage medium, comprising some instructions to cause a computer device (a personal computer, a server or a network device and so on) to execute all or a part of the method as recited in the arrangements of the present disclosure. The foregoing storage medium includes: any medium that can store program code, such as a universal serial bus (USB) flash drive, a removable hard disk, a read-only memory (ROM), a random-access memory (RAM), a magnetic disk, or an optical disc.

Those of ordinary skill in the art may understand that the foregoing arrangements are merely intended for describing the technical solutions of the present disclosure, but not for limiting the present disclosure. Although the present disclosure is described in detail with reference to the foregoing arrangements, persons of ordinary skill in the art should understand that they may still make modifications to the technical solutions described in the foregoing arrangements or make equivalent replacements to some or all technical features thereof, without departing from the scope limited by the claims of the present disclosure.

What is claimed is:

1. A display control apparatus, used in a foldable display apparatus, the display apparatus comprising a first display area and a second display area respectively positioned on two sides of a fold line, wherein the display control apparatus comprises:
a status obtaining module, configured to determine either one of the first display area and the second display area as a primary display area and determine the other one as a secondary display area in response to a trigger action;
a resolution adjusting module, configured to adjust image data transmitted to the display apparatus to match a resolution of the primary display area; and
a display control module, configured to control the primary display area to display based on the image data received by the display apparatus.

2. The display control apparatus according to claim 1, wherein the display control module is further configured to control the secondary display area to go into a standby mode.

3. The display control apparatus according to claim 1, wherein the determining either one of the first display area and the second display area as the primary display area and determining the other one as a secondary display area in response to the trigger action comprises:
detecting whether the trigger action is a first trigger action or a second trigger action;
determining the first display area as the primary display area and determining the second display area as the secondary display area when the trigger action is the first trigger action; and
determining the second display area as the primary display area and determining the first display area as the secondary display area when the trigger action is the second trigger action.

4. The display control apparatus according to claim 1, wherein the determining either one of the first display area and the second display area as the primary display area and determining the other one as the secondary display area in response to the trigger action comprises:
detecting whether a folding action is received, and obtaining a folding direction when the folding action is received;
determining the first display area as the primary display area and determining the second display area as the secondary display area when the obtained folding direction is a first direction; and
determining the second display area as the primary display area and determining the first display area as the secondary display area when the obtained folding direction is a second direction.

5. The display control apparatus according to claim 1, wherein the determining either one of the first display area and the second display area as the primary display area and determining the other one as the secondary display area in response to the trigger action comprises:
determining either one of the first display area and the second display area as the primary display area and determining the other one as the secondary display area based on a user command when a selecting operation of power saving mode is received.

6. The display control apparatus according to claim 5, wherein the power saving mode comprises a standby mode or an always-on-display mode.

7. A display control method, used in a foldable display apparatus, the display apparatus comprising a first display area and a second display area respectively positioned on two sides of a fold line, wherein the display control method comprising:
determining either one of the first display area and the second display area as a primary display area and determining the other one as a secondary display area in response to a trigger action;
adjusting image data transmitted to the display apparatus to match a resolution of the primary display area; and
controlling the primary display area to display based on the image data received by the display apparatus.

8. The display control method according to claim 7, further comprising: controlling the secondary display area to go into a standby mode.

9. The display control method according to claim 7, wherein the determining either one of the first display area and the second display area as the primary display area and determining the other one as the secondary display area in response to the trigger action comprises:
detecting whether the trigger action is a first trigger action or a second trigger action;
determining the first display area as the primary display area and determining the second display area as the secondary display area when the trigger action is the first trigger action; and
determining the second display area as the primary display area and determining the first display area as the secondary display area when the trigger action is the second trigger action.

10. The display control method according to claim 7, wherein the determining either one of the first display area and the second display area as the primary display area and determining the other one as the secondary display area in response to the trigger action comprises:
detecting whether a folding action is received, and obtaining a folding direction when the folding action is received;
determining the first display area as the primary display area and determining the second display area as the secondary display area when the obtained folding direction is a first direction; and
determining the second display area as the primary display area and determining the first display area as the secondary display area when the obtained folding direction is a second direction.

11. The display control method according to claim 7, wherein the determining either one of the first display area and the second display area as the primary display area and determining the other one as the secondary display area in response to the trigger action comprises:
determining one of the first display area and the second display area as the primary display area and determining the other one as the secondary display area based on a user command when a selecting operation of power saving mode is received.

12. The display control method according to claim 11, wherein the power saving mode comprises a standby mode or an always-on-display mode.

13. The display control method according to claim 7, further comprising:
detecting whether a flip angle of a spatial attitude of the display apparatus is greater than a value; and
controlling the first display area and the second display area to switch over display contents when detecting that the flip angle of the spatial attitude of the display apparatus is greater than the value.

14. A foldable display apparatus, comprising:
a first display area and a second display area positioned on two sides of a fold line;
a processor; and
a memory, having a computer-executable instruction stored thereon, that when executed by the processor, caused the processor to,
determine either one of the first display area and the second display area as a primary display area and determine the other one as a secondary display area in response to a trigger action;
adjust image data transmitted to the display apparatus to match a resolution of the primary display area; and
control the primary display area to display based on the image data received by the display apparatus.

15. The foldable display apparatus according to claim 14, wherein when the computer-executable instruction is executed by the processor, the processor is further caused to control the secondary display area to go into a standby mode.

16. The foldable display apparatus according to claim 14, wherein the determining either one of the first display area and the second display area as the primary display area and determining the other one as the secondary display area in response to the trigger action comprises:
detecting whether the trigger action is one of a first trigger action and a second trigger action;
determining the first display area as the primary display area and determining the second display area as the secondary display area when the trigger action is the first trigger action;
determining the second display area as the primary display area and determining the first display area as the secondary display area when the trigger action is the second trigger action.

17. The foldable display apparatus according to claim 14, wherein the determining either one of the first display area and the second display area as the primary display area and determining the other one as the secondary display area in response to the trigger action comprises:
detecting whether a folding action is received, and obtaining a folding direction when the folding action is received;
determining the first display area as the primary display area and determining the second display area as the secondary display area when the obtained folding direction is a first direction;
determining the second display area as the primary display area and determining the first display area as the secondary display area when the obtained folding direction is a second direction.

18. The foldable display apparatus according to claim 14, wherein the determining either one of the first display area and the second display area as the primary display area and determining the other one as the secondary display area in response to the trigger action comprises:
determining one of the first display area and the second display area as the primary display area and determining the other one as the secondary display area based on a user command when a selecting operation of power saving mode is received.

19. The foldable display apparatus according to claim 18, wherein the power saving mode comprises one of a standby mode and an always-on-display mode.

20. The foldable display apparatus according to claim 14, wherein when the computer-executable instruction is executed by the processor, the processor is further caused to:
detect whether a flip angle of a spatial attitude of the display apparatus is greater than a value; and
control the first display area and the second display area to switch over display contents when detecting that the flip angle of the spatial attitude of the display apparatus is greater than the value.
